(19) United States
(12) Patent Application Publication
(10) Pub. No.: US 2025/0178440 A1
(43) Pub. Date: Jun. 5, 2025

(54) POWER SUPPLY SYSTEM

(71) Applicant: HITACHI ASTEMO, LTD., Hitachinaka-shi, Ibaraki (JP)

(72) Inventors: Nobuyasu KANEKAWA, Chiyoda-ku, Tokyo (JP); Hiroshi NAKANO, Chiyoda-ku, Tokyo (JP); Kentaro JUMONJI, Hitachinaka-shi, Ibaraki (JP)

(73) Assignee: HITACHI ASTEMO, LTD., Hitachinaka-shi, Ibaraki (JP)

(21) Appl. No.: 18/842,070

(22) PCT Filed: Mar. 2, 2023
(86) PCT No.: PCT/JP2023/007851

§ 371 Date: Aug. 28, 2024

(30) Foreign Application Priority Data
Apr. 11, 2022 (JP) 2022-064899

(51) Int. Cl. B60L 1/00; H02J 1/08; H02J 1/10

(52) U.S. Cl. CPC B60L 1/00; H02J 1/086; H02J 1/106

(57) ABSTRACT

The power supply system related to the present invention includes plural power sources for supplying power to a single load in a vehicle, plural power supply paths for connecting the single load and each of the plural power sources, and a current adjustment unit for adjusting current flowing through at least one of the plural power supply paths, and the current adjustment unit compares state quantities of electrical states of each of the power supply paths, and, when a difference between the state quantities meets prescribed conditions, adjusts current flowing through the power supply paths so as to reduce the difference between the state quantities.

### TECHNICAL FIELD

The present invention relates to a power supply system, and relates, for example, to an on-vehicle power supply system suitable to an electromotive automobile.

### BACKGROUND ART

Electrification of an auxiliary machine of an automobile such as an electronic power assisted steering and an electric brake has been developed for some time. Also, in recent years, electrification of a main machine itself has advanced as is represented by a hybrid vehicle and an electric vehicle. Also, automated driving has also advanced, and it will be required gradually that driving of an automobile will be concluded by an autonomous and automated operation without involvement of human being even in breakdown from now on. From such background, high performance and high reliability (failure-time operation continuity) of an on-vehicle power supply system supporting electrification and automation of an automobile have been required.

With respect to the technology described above, in Patent Literature 1 for example, there is disclosed a technology on redundancy of a power source unit in addition to redundancy of a control unit, and there is also disclosed a technology for operating a control unit in a power saving mode when a power source unit fails.

### CITATION LIST

### Patent Literature

Patent Literature 1: Japanese Unexamined Patent Application Publication No. 2014-193720

### SUMMARY OF INVENTION

### Technical Problem

According to the technologies of a prior art described above, when the power distribution function is made redundant for the purpose of failure-time operation continuity, increase of the cost results, and therefore further consideration is desirable with respect to cost reduction.

Therefore, the object of the present invention is to suppressing redundancy for achieving prescribed failure-time operation continuity and to utilize indispensable redundancy to improve performance of a power distribution function such as deconcentration of a load on a current path.

### Solution to Problem

In order to achieve the object described above, a power supply system related to the present invention includes plural power sources for supplying power to a single load in a vehicle, plural power supply paths for connecting the single load and each of the plural power sources, and a current adjustment unit for adjusting current flowing through at least one of the plural power supply paths, and the current adjustment unit compares state quantities of electrical states of each of the power supply paths, and, when a difference between the state quantities meets prescribed conditions, adjusts current flowing through the power supply paths so as to reduce the difference between the quantities.

### Advantageous Effects of Invention

By employing the configuration described above, the present invention can suppress redundancy for achieving prescribed failure-time operation continuity and utilize indispensable redundancy to improve performance of a power distribution function such as deconcentration of a load on a current path.

Further characteristics related to the present invention will be clarified from the contents of the present description and the attached drawings. Also, problems, configurations, and effects other than those described above will be clarified by explanation of embodiments described below.

### BRIEF DESCRIPTION OF DRAWINGS

FIG. 1 is a schematic drawing illustrating a basic configuration of the present invention.

FIG. 2 is a drawing illustrating a configuration where a controlling variable resistor is arranged on the downstream side in the basic configuration of the present invention.

FIG. 3 is a drawing illustrating control by switching in the basic configuration of the present invention.

FIG. 4 is a drawing illustrating control combining switching in the basic configuration of the present invention.

FIG. 5 is a drawing for explaining combination of output voltage control and switching control of a voltage source.

FIG. 6 is a block diagram illustrating a configuration of an electronic control unit related to an embodiment.

FIG. 7 is a block diagram illustrating a functional configuration of a control unit.

FIG. 8 is a drawing illustrating a process of a control unit based on an average current.

FIG. 9 is a drawing illustrating a process of the control unit based on mean square of a current.

FIG. 10 is a block diagram illustrating a configuration of an electronic control unit connected to a wire harness.

FIG. 11 is a drawing illustrating a process of the control unit based on total current.

FIG. 12 is a drawing illustrating a process of the control unit based on temperature rise.

FIG. 13 is a drawing illustrating a configuration of the control unit having a failure responding function.

FIG. 14 is a drawing illustrating a process of the control unit having a failure responding function.

FIG. 15 is a block diagram illustrating a summary of an on-vehicle power supply network.

FIG. 16 is a drawing illustrating an example of power supply to an important load.

FIG. 17 is a drawing illustrating another example of power supply to an important load.

FIG. 18 is a drawing illustrating an example of a configuration of a 2-input switching regulator.

FIG. 19 is a drawing illustrating another example of a configuration of the 2-input switching regulator.

FIG. 20 is a drawing illustrating another example of a configuration of the 2-input switching regulator.

FIG. 21 is a drawing illustrating another example of a configuration of the 2-input switching regulator.

FIG. 22 is a drawing illustrating an example of a configuration of an on-vehicle power supply network using a 2-input switching regulator.

### DESCRIPTION OF EMBODIMENTS

Embodiments of the present invention will be hereinafter explained according to the drawings.

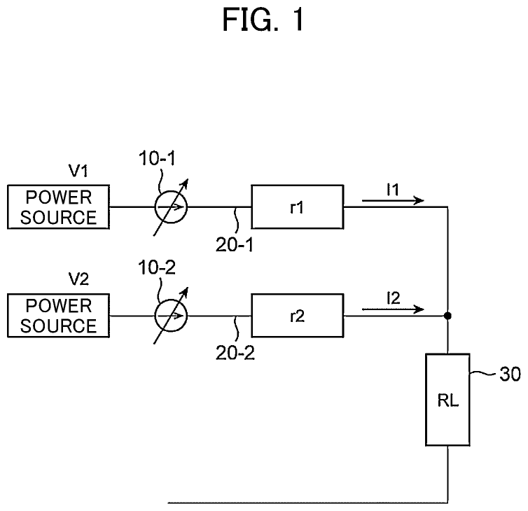

FIG. 1 is a drawing illustrating a basic configuration in an embodiment of a power supply system related to the present invention.

A power supply system includes plural power sources supplying power to a single load RL, plural current paths 20-1, 20-2 connecting the load RL and the plural power sources, and a current adjustment means 10-1, 10-2 arranged in each of the plural current paths 20-1, 20-2 and adjusting the current flowing through the current paths 20-1, 20-2. Also, voltage of the plural power sources is made V1, V2 respectively, and wiring resistance of the current paths 20-1, 20-2 is made r1, r2 respectively. Further, although the current adjustment means 10-1, 10-2 is disposed on the upstream side of the current paths 20-1, 20-2 in FIG. 1, the current adjustment means 10-1, 10-2 may be disposed on the downstream side. Here, the upstream side of the current path means a region comparatively nearer to the power source between the power source and the load, and the downstream side means a region nearer to the load.

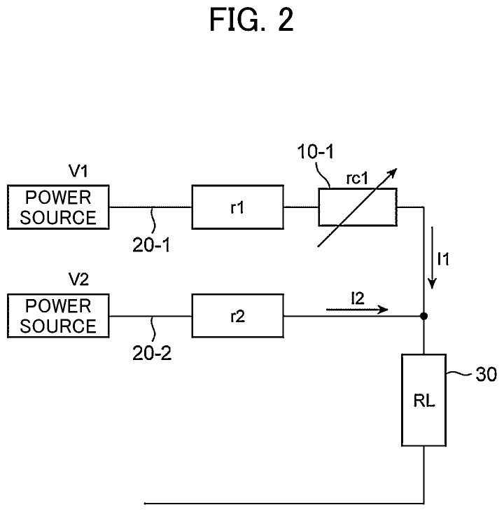

The current adjustment means 10-1, 10-2 can employ a controlling variable resistor configured of a semiconductor element such as an FET (Field Effect Transistor) for example. FIG. 2 illustrates an example where a controlling variable resistor rc1 is inserted in series on the downstream side of the current path as the current adjustment means 10-1.

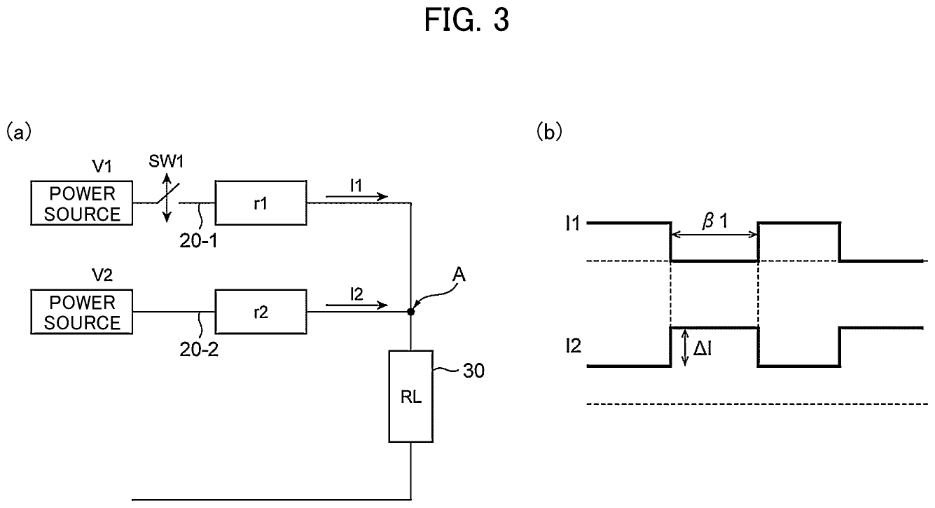

FIG. 3 illustrates an example of adjusting the current flowing through the current path by switching. As illustrated in FIG. 3 (a), in the present embodiment, a switching element SW1 is disposed on the upstream side of the current path 20-1 as the current adjustment means 10-1. ON/OFF of the current flowing through the current path 20-1 is switched by the switching element SW1, and the current flowing through the current path 20-2 is made to be always ON. The waveform of this time is illustrated in FIG. 3 (b).

As illustrated in FIG. 3 (b), current I1 flowing through the current path 20-1 flows during an ON-time of SW1, and becomes 0 during an OFF-time β1 of SW1. A current I2 flowing through the another current path 20-2 increases during the OFF-time β1 of SW1 since all currents flow through the current path 20-2, and decreases during the ON-time of SW1 since the current flows through the current path 20-1 also. According to this configuration, when there are plural current paths, a current comes to flow through a part of the current paths always. Therefore, even when a current of another current path is cut off, the current does not become 0 sharply as a whole circuit. In an ordinary switching regulator, when the flowing current becomes 0 sharply, there is a risk that fly-back voltage and a noise occur to cause a circuit failure, and a reflux diode, a choke coil, and the like become necessary in order to suppress them, however they become unnecessary according to the present embodiment. Also, by adjusting the current flowing through one current path, concentration of heat generation to one current path can be prevented, and heat generation among the current paths can be kept balanced. Further, although a case where there exist two current paths was explained in the present embodiment, the number of piece of the current path is not limited to it.

Here, the current I1, I2 flowing through the current path 20-1, 20-2 when the output voltage of the power source is made V1, V2, the resistance of the current path is made r1, r2, and the resistance of the load is made RL is obtained. When the voltage at a point A is watched, by the Kirchhoff's law,

$$V 1 - r 1 I 1 = V 2 - r 2 I 2 = ( I 1 + I 2 ) RL \qquad ( 1 )$$

Here, from (the first member=the second member) of the equation (1),

$$I 1 = ( V 1 - V 2 + r 2 I 2 ) / r 1 \qquad ( 2 )$$

Also, from (the second member=the third member) of the equation (1), when the equation (2) is substituted into the third member,

$$I 2 = \{ ( RL + r 1 ) V 2 - RL V 1 \} / \{ r 1 r 2 + ( r 1 + r 2 ) RL \} \qquad ( 3 )$$

When the equation (2) is substituted into the equation (3),

$$I 1 = \{ ( RL + r 2 ) V 1 - RL V 2 \} / \{ r 1 r 2 + ( r 1 + r 2 ) RL \} \qquad ( 4 )$$

Then, an average current I1ave, I2ave flowing through the current path 20-1, 20-2 when either one of the current path 20-1 and the current path 20-2 is made OFF for the time of β1, β2 (duty cycle is 1-β1 or 1-β2) and another current path is made always ON (duty cycle is 1) is obtained.

First, as illustrated in FIG. 3(b), since the current I1 flows through the current path 20-1 of the time when the current path 20-1 is made OFF for β1 (duty cycle is 1-β1) and the current path 20-2 is made always ON (duty cycle is 1) only when the current path 20-1 is made ON,

$$I 1 ave = ( 1 - β1 ) I 1 \qquad ( 5 )$$

Also, through the current path 20-2, 12 obtained by the equation (3) flows when the current path 20-1 is made ON, a current of

$$I {2}^{′} = V 2 / ( r 2 + RL ) \qquad ( 6 )$$

flows when the current path 20-1 is made OFF, and the average current thereof becomes

$$I 2 ave = ( 1 - β1 ) I 2 + β1 I {2}^{′} \qquad ( 7 )$$

In a similar manner, since the current I2 flows through the current path 20-2 of the time when the current path 20-2 is made OFF for β2 (duty cycle is 1-62 2) and the current path 20-1 is made always ON (duty cycle is 1) only when the current path 20-2 is made ON,

$$I 2 ave = ( 1 - β2 ) I 2 \qquad ( 8 )$$

On the other hand, through the current path 20-1, I1 obtained by the equation (4) flows when the current path 20-2 is made ON, a current of

$$I {1}^{′} = V 1 / ( r 1 + RL ) \qquad ( 9 )$$

flows when the current path 20-2 is made OFF, and the average current becomes

$$I 1 ave = ( 1 - β1 ) I 1 + β1 I {1}^{′} \qquad ( 10 )$$

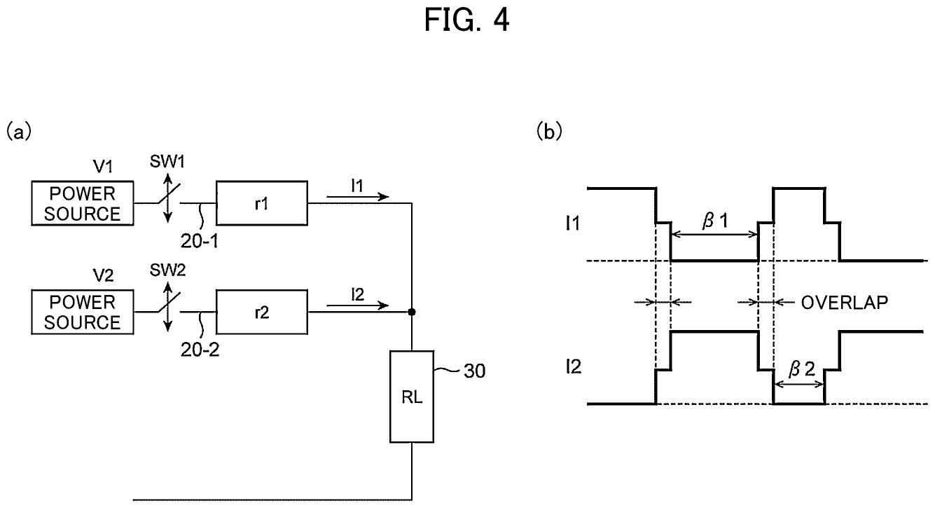

FIG. 4 is a drawing illustrating a configuration of disposing a current adjustment means in both of the current paths 20-1, 20-2 and adjusting the current flowing through the current paths 20-1, 20-2 by pulse width modulation (PWM). In the present embodiment, as illustrated on the left side of FIG. 4 (a), the switching element SW1, SW2 is arranged on the upstream side of the current path 20-1, 20-2 as the current adjustment means 10-1, 10-2 (refer to FIG. 1). Also, the current flowing through the current path 20-1, 20-2 is adjusted by turning on/off of SW1, SW2.

In concrete terms, the switching elements SW1, SW2 are turned on/off alternatively, the current path 20-1 is made OFF only for the time β1, and the current path 20-2 is made OFF only for the time β2. In this case, by making the time when both is made ON overlap with each other (by not making the duty time β1, β2 overlap with each other) as illustrated in FIG. 4 (b), the current comes to flow through the current path of one side always. Therefore, since the current does not become 0 sharply as a whole circuit even when a current of another current path is cut off, a reflux diode, a choke coil, and the like required for an ordinary switching regulator become unnecessary. Also, by adjusting the current flowing through one current path, concentration of heat generation to one current path can be prevented, and heat generation among the current paths can be kept balanced. Also, the time β1, β2 for making the current path OFF can be set appropriately.

Also, it is preferable that a surge and noise caused by inductance of the current path 20-1, 20-2 can be suppressed by making switching of the switching element SW1, SW2 soft switching limiting the hourly current change rate di/dt. Also, semiconductor elements such as MOSFET can be used for the switching element SW1, SW2, and soft switching can be executed by controlling the gate drive voltage so as to change moderately or having a time constant circuit by a resistor or a capacitor.

Also, with respect to adjustment of the current between the current paths by the present invention, it is also possible to balance heat generation between the current paths and to prevent heat generation from being concentrated to one current path. For such purpose, frequency of switching of PWM only has to be shorter than the thermal time constant of the current path as described above. In concrete terms, the frequency of switching of PWM may be frequency as low as approximately several hundreds milliseconds to several seconds. Therefore, increase of the switching loss proportional to the switching number of times is also negligible.

Also, in the method of adjusting the current flowing through the current path 20-1 and the current path 20-2 by PWM switching as illustrated in FIG. 3, 4, a period when the current does not flow in either one of the current paths occurs, and the utilization efficiency of the current path drops. In other words, since heat generation of a current path is proportional to the square of the current, when the hourly average current is same, heat generation of the whole current path can be reduced when a constant current is made to flow continuously compared to a case of making the current to flow intermittently. For example, between the case of making the current I flow continuously and the case of making the current 21 to flow with the duty of 50%, although the average current is I in both cases, since heat generation is proportional to the square of the current, when heat generation of the former is made I2R, heat generation of the latter becomes (2I)2R/2=2I2R.

On the other hand, according to the embodiment where the current is adjusted by the control variable resistor rc1 as illustrated in FIG. 2, heat generation of I2R is caused by the control variable resistor. Although there is no big difference of increase of heat generation between the both, since heat generation is concentrated to the control variable resistor rc1 in the embodiment illustrated in FIG. 2, new cost is incurred for implementation of radiation such as a radiator for radiating generated heat, whereas in the embodiment illustrated in FIG. 3 and FIG. 4, since heat generation is dispersed widely over the whole current path, it is necessary to arrange a radiator, and cost reduction can be achieved.

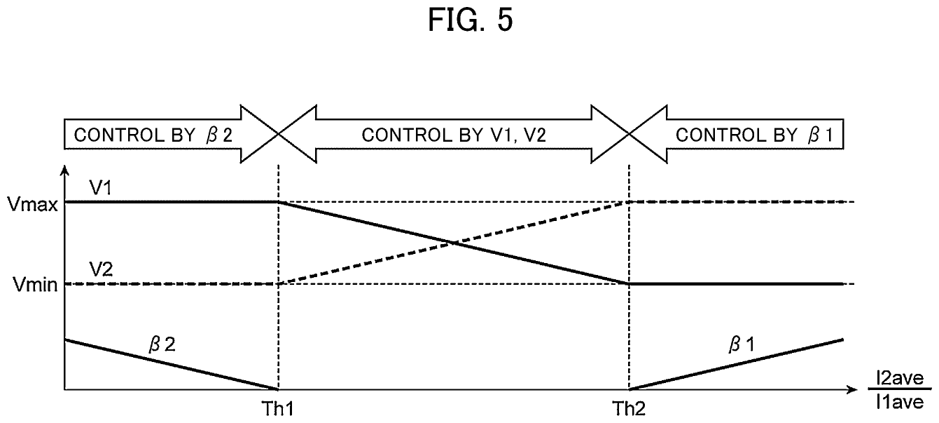

FIG. 5 is a drawing illustrating an example of changing the adjustment method of the current according to the magnitude of difference in the current flowing in adjusting the current flowing through the current path 20-1, 20-2.

With respect to the method of adjusting the current flowing through the current path 20-1, 20-2 by PWM, as described above, a period when the current does not flow in either one of the current paths occurs, and the utilization efficiency of the current path drops as described above. Therefore, when the current flowing through the current path 20-1, 20-2 is adjusted by the output voltage V1, V2 of the voltage source to allow the current to flow through both of the current paths always, the utilization efficiency of the current path improves, and heat generation of the whole current path can be reduced.

On the other hand, the range where the output voltage V1, V2 of the voltage source can be adjusted is limited by the operation voltage range of a load, and so on. For example, the output voltage range of the power source of a 12V system is approximately 12V (12V to 14V for example), and, when the output voltage deviates largely from this range, a problem occurs in operation of the load. Further, although the output voltage can be adjusted when the power source is a regulator and a DC/DC convertor by switching operation, if the power source is a secondary battery, since the output voltage depends on the state of charge (SOC), it is not possible to change only the output voltage independently.

Therefore, when the current ratio (I2ave/I1ave) of the currents flowing through the current paths 20-1, 20-2 is within a constant range and the output voltage V1, V2 can be adjusted within the range of Vmax to Vmin as illustrated in FIG. 5, the current flowing through the current path 20-1, 20-2 is adjusted by the output voltage V1, V2 of the voltage source. Also, when the difference of the currents flowing through the current paths 20-1, 20-2 is large and the output voltage V1, V2 cannot be adjusted within the range of Vmax to Vmin, the current flowing through the current path 20-1, 20-2 is controlled and balanced by PWM switching (the duty time is set to β1, β2). Thus, by combination of PWM and output voltage adjustment, heat generation over the whole current path can be reduced and the efficiency can be optimized. Further, although FIG. 5 illustrates with respect to the current ratio, it is also possible to use a ratio of the heat generation amount of the current paths 20-1, 20-2.

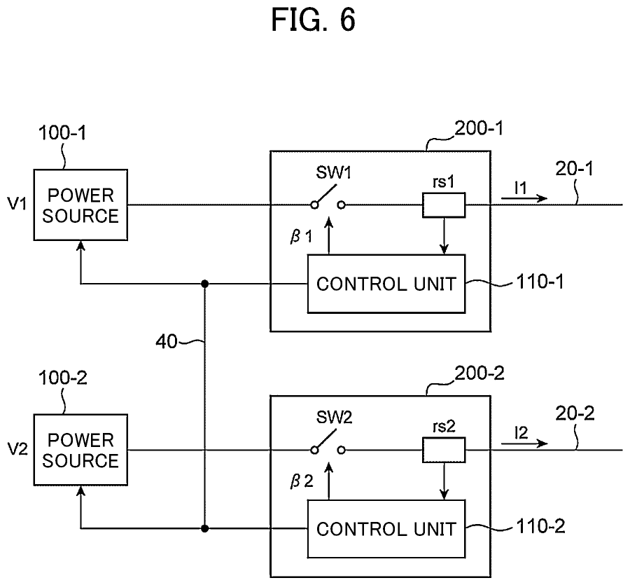

FIG. 6 is a block diagram illustrating an example of a configuration of an electronic control unit for achieving the present invention. Power sources 100-1, 100-2 respectively supply power to electronic control units (ECU) 200-1, 200-2, and the electronic control units 200-1, 200-2 adjust the current flowing through the current paths 20-1, 20-2. The electronic control units 200-1, 200-2 respectively include shunt resistors rs1, rs2 for current detection function or current detection, control units 110-1, 110-2 for adjusting the current, and the switching elements SW1, SW2 for switching the current.

The control units 110-1, 110-2 turn on/off the switching elements SW1, SW2 switching the current and controls the setting value of the output voltage V1, V2 of the power sources 100-1, 100-2 based on the value of the currents I1, I2 flowing through the current paths 20-1, 20-2 detected by the shunt resistors rs1, rs2 for current detection function or current detection, the average value and the mean square value thereof, and the heat generation amount of the current paths 20-1, 20-2 estimated from the value of the current I1, I2. Between the power sources 100-1, 100-2 and the control units 110-1, 110-2 is connected by a communication path 40, and the setting values of the output voltage V1, V2 of the power sources 100-1, 100-2, the values of the currents I1, I2, and so on are transmitted through the communication path 40. Also, the form of the communication path 40 may be individual wiring or a network.

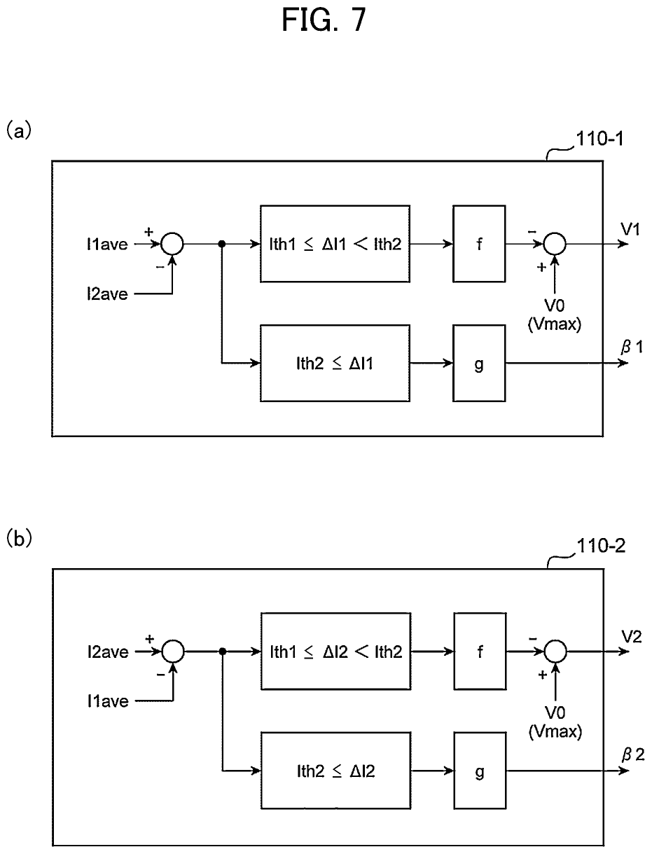

An example of the functional configuration of the control unit 110-1, 110-2 is illustrated in FIG. 7. As illustrated in FIG. 7 (a), the control unit 110-1 does not adjust the current flowing through the current path 20-1 when the difference I1ave−I2ave (will be referred to as ΔI1) of the average values I1ave, I2ave of the current I1, I2 is less than a threshold Ith1. When the average current difference ΔI1 is equal to or greater than the threshold Ith1 and less than the threshold Ith2, the current is adjusted by controlling the setting value of the output voltage V1 of the power source 100-1. Also, when the average current difference ΔI1 is equal to or greater than the threshold Ith2, the current control operation is executed by PWM switching (the duty time is set to β1).

Also, as illustrated in FIG. 7 (b), with respect to the control unit 110-2 also, the current flowing through the current path 20-2 is adjusted by the magnitude relation between the average current difference I2ave−I1ave (ΔI2) and the threshold Ith1, Ith2. Also, as can be understood from the above, the thresholds Ith1 and Ith2 correspond to the lower limit value and the upper limit value where the output power of the power sources 100-1, 100-2 can be adjusted.

Also, here, g, f illustrated in FIG. 7 is a function where the input and output may be in a proportional relation by a constant proportionality factor, and may be of a PID control system. Also, in obtaining the average current I1ave, I2ave, a method by a value of integral, an exponential moving average, and the like of the current I1, 12 of a predetermined period can be employed. According to the exponential moving average, the latest exponential moving average value can be obtained by that the calculation result of the exponential moving average of the past and the present value of the current are respectively multiplied by a factor and the results are added, and this calculation is to be repeated at every predetermined frequency, and therefore the calculation amount can be reduced.

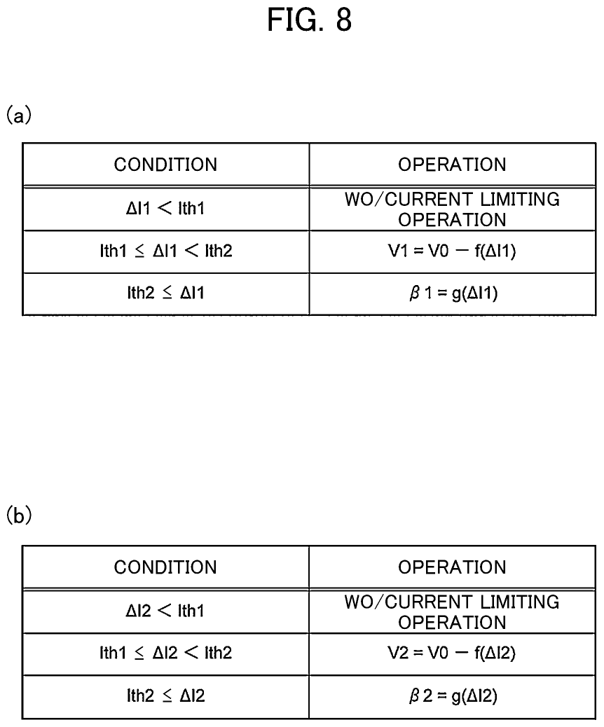

A table summarizing the operations of the control unit 110-1 described above is illustrated in FIG. 8 (a). In a similar manner, the operations by the control unit 110-2 are summarized also as per FIG. 8 (b).

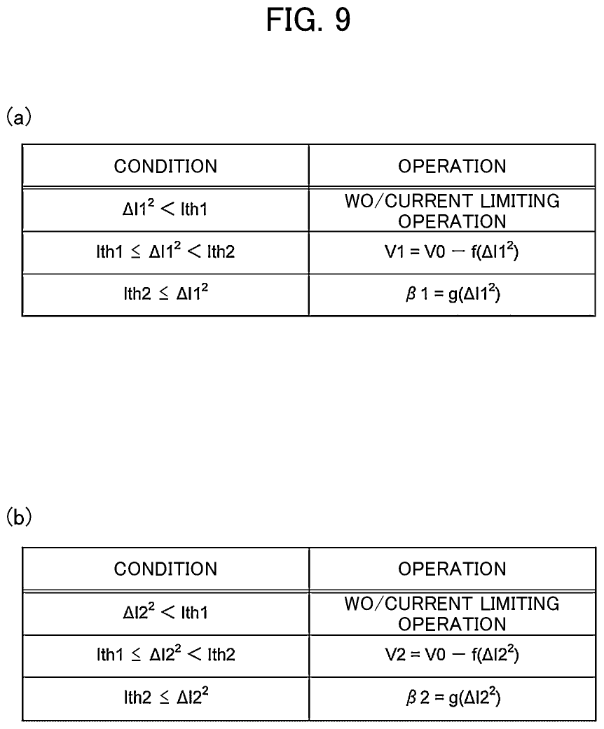

Also, since heat generation in the current path 20-1, 20-2 is proportional to the square of the current, the operation executed by the control unit 110-1, 110-2 with an indicator of the mean square I12ave, I22ave of the current in a proportional relation with the heat generation amount on the current path 20-1, 20-2 is illustrated in FIG. 9. As illustrated in FIG. 9 (a), when the mean square difference I12ave−I22ave of the current (will be referred to as ΔI2) is less than a threshold Ith1, since the heat generation amount of the both is not required to be adjusted, the control unit 110-1 does not adjust the current flowing through the current path 20-1. When ΔI2 is equal to or greater than the threshold Ith1 and less than the threshold Ith2, the current is adjusted by controlling the setting value of the output voltage V1 of the power source 100-1. Also, when ΔI2 is equal to or greater than the threshold Ith2, the current control operation is executed by PWM switching (the duty time is set to β1).

Also, as illustrated in FIG. 9 (b), with respect to the control unit 110-2 also, the current flowing through the current path 20-2 is adjusted by the magnitude relation between the mean square average difference I22ave−I12ave (ΔI22) of the current and the threshold Th1, Th2.

According to the embodiment described above, by sharing the power supply amount (the average current, the mean square of the current, the total current, and the temperature rise) in a balanced fashion in the normal time between the current paths 20-1, 20-2 arranged by a plural number of piece, the power supply efficiency can be optimized, and the rated capacity required for each of the current paths 20-1, 20-2 can be reduced. Also, when the power supply amount is not well balanced between the current paths 20-1, 20-2, if a failure occurs in one current path whose power supply amount is larger, the reserved capacity of power supply capability drops. However, by adjusting the power supply amount between the current paths 20-1, 20-2 in a balanced fashion as done in the present embodiment, the reserved capacity of power supply capability from other current path can be assured when one current path failures.

Also, in a similar manner, by balancing the power source capacity (the charging residual amount and the voltage of the battery) between the current paths 20-1, 20-2 in the normal time, the reserved capacity of power supply capability from other current path can be assured when one current path failures.

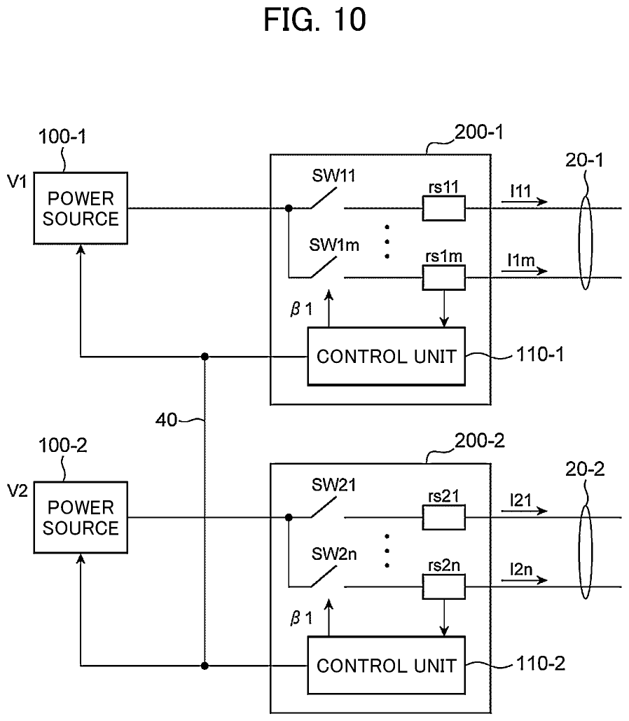

Although explanation was made in the example described above that the current path 20-1, 20-2 was configured by a single signal line, in an on-vehicle power supply network, it is common that the current path is wired as a bundled wire called a wire harness obtained by bundling plural wires and control signal lines as illustrated in FIG. 10. Therefore, as illustrated in FIG. 10, the electronic control unit 200-1, 200-2 supplies power to plural wires, detects the current I11 to I2n flowing through each wire by the current detection function or the shunt resistor rs11 to rs2n, and can execute the current adjustment motion by the control unit 110-1, 110-2 based on them.

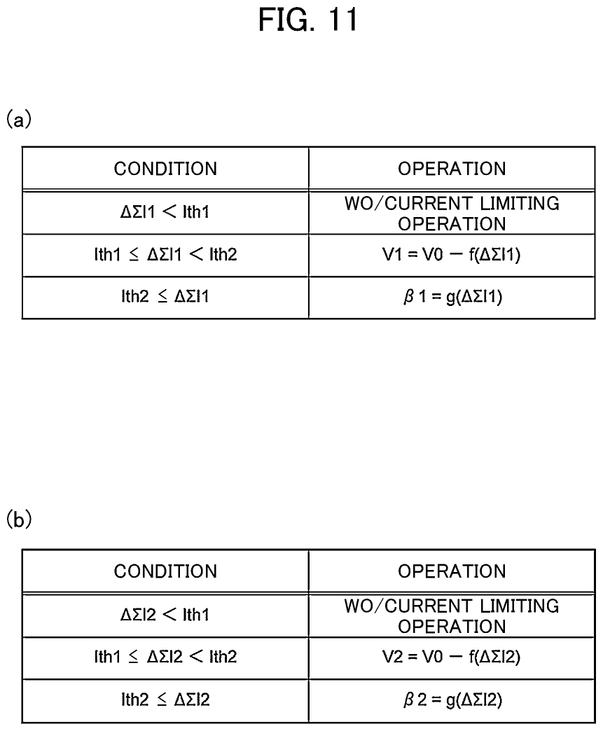

FIG. 11 illustrates an operation of the control unit 110-1, 110-2 executing the current control motion with an indicator of the total current ΣI1, ΣI2 flowing through the current path 20-1, 20-2 corresponding to a case where the current path is wired as a bundled wire called a wire harness obtained by bundling plural wires and control signal lines as described above.

Each of the total current 211, 212 flowing through the current path 20-1, 20-2 is expressed by the following expressions.

$$\sum I 1 = \sum I 1 j ( j is 1 to m ) \qquad ( 11 )$$

$$\sum I 2 = \sum I 2 j ( j is 1 to n ) \qquad ( 12 )$$

Also, as illustrated in FIG. 11 (a), (b), the control unit 110-1, 110-2 adjusts the current flowing through the current path 20-1, 20-2 by the magnitude relation between the difference ΣI1−ΣI2 (ΔΣI1), ΣI2−ΣI1 (ΔΣI2) of the total current described above and the threshold Ith1, Ith2.

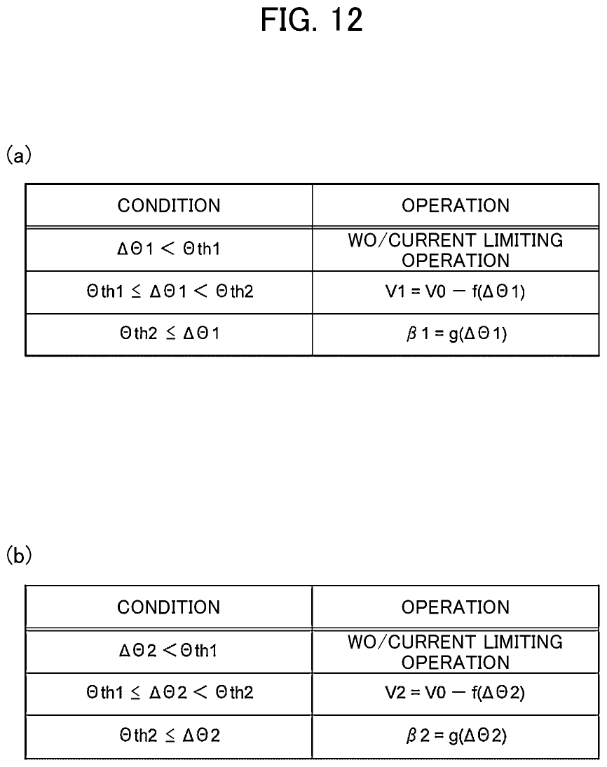

Further, it is also possible that the control unit 110-1, 110-2 adjusts the current with an indicator of the temperature rise Θ1, Θ2 in the current path 20-1, 20-2. The operation executed by the control unit 110-1, 110-2 then is illustrated in FIG. 12. In this case also, in a manner similarly to other examples, as illustrated in FIG. 12 (a), (b), the control unit 110-1, 110-2 adjusts the current flowing through the current path 20-1, 20-2 by the magnitude relation between the difference Θ1−Θ2 (ΔΘ1), Θ2−Θ1 (ΔΘ2) of the temperature rise described above and the threshold Θth1, Θth2. Further, although the temperature rise Θ1, Θ2 may be an actual measurement value, it may be an estimated value based on the current I1, I2 or the total current ΣI1, ΣI2 flowing through the current path 20-1, 20-2.

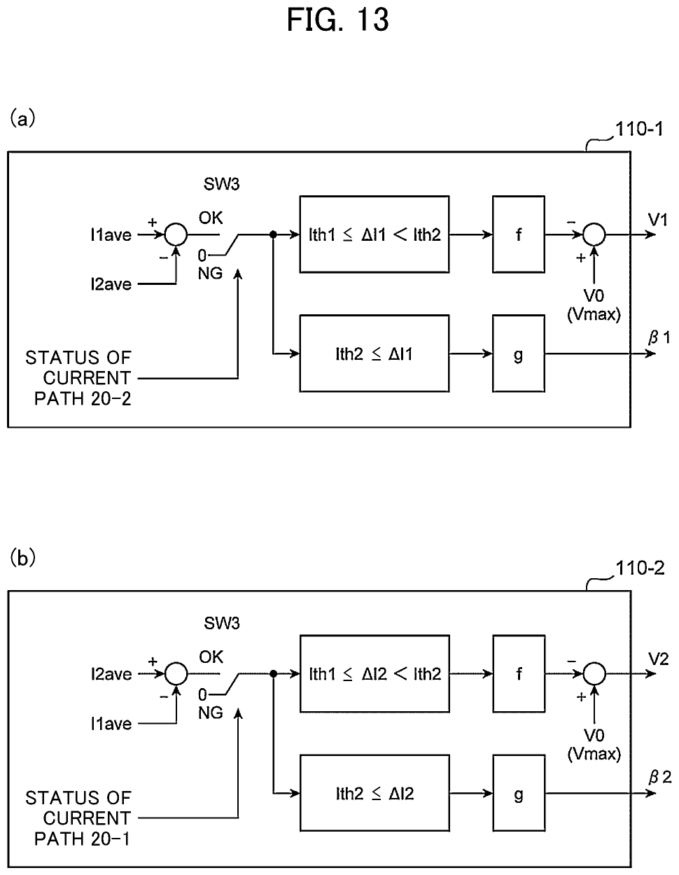

Next, an operation executed by the control unit 110-1, 110-2 when a failure occurs in one power path among two current paths is illustrated in FIG. 13. As illustrated in FIG. 13 (a), in the control unit 110-1, there is arranged a switching element SW3 switching connection of the current path 20-2 to the load. Also, when the status of the current path 20-2 is OK namely when a failure does not occur in the current path 20-2, the control unit 110-1 makes SW3 ON, makes connection of the current path 20-2 to the load ON, and executes the operation similar to that of the embodiment described above. When the status of the current path 20-2 is NG namely when a failure occurs in the current path 20-2, the switching element SW3 selects 0 to disconnect the current path 20-2 to the load. Also, the control unit 110-1 does not adjust the current flowing through the current path 20-1, and supplies power to the load as per rating. The control unit 110-2 controlling the current path 20-2 also operates similarly based on the status of the current path 20-1 as illustrated in FIG. 13 (b). Thus, when a failure may occur in one power path, power can be supplied only from the other power supply path, and the operation can be continued.

Also, it is also possible that the current adjustment operation by the present embodiment is to be executed only when the current path 20-1, 20-2 is overheated namely when the actual measurement value or the estimated value of the temperature of the current path 20-1, 20-2 is higher than a predetermined threshold, and is not to be executed when the current path 20-1, 20-2 is not overheated namely when the actual measurement value or the estimated value of the temperature of the current path 20-1, 20-2 is lower than the predetermined threshold.

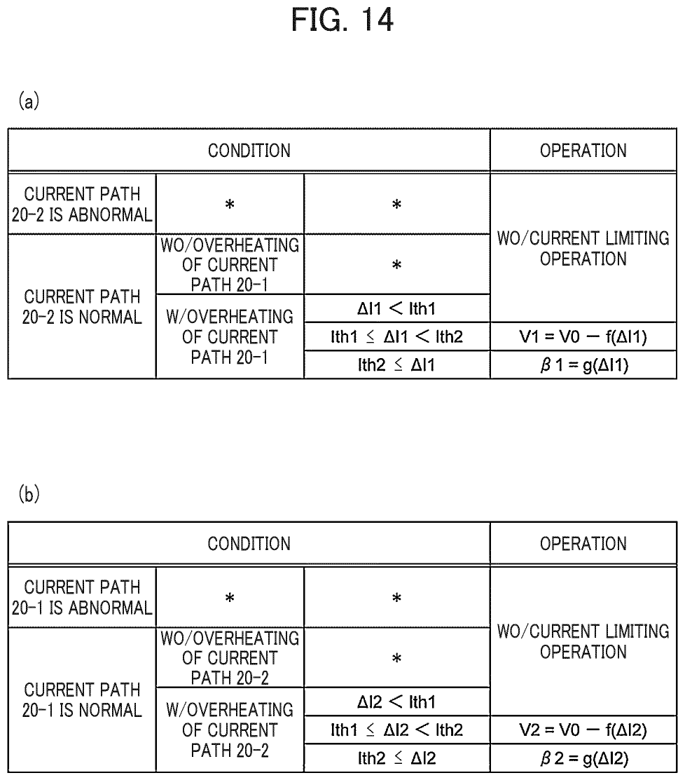

The operation executed by the control unit 110-1, 110-2 in this case is illustrated in FIG. 14. As illustrated in FIG. 14 (a), the control unit 110-1 executes current adjustment explained in FIG. 8 and the like when the current path 20-2 is normal namely when the current path 20-2 has no failure and the current path 20-2 is overheated. Also, the control unit 110-1 does not execute current limiting operation when the current path 20-2 is abnormal namely when the current path 20-2 has a failure, or when the current path 20-2 is not overheated. Also, the control unit 110-2 also executes the operation illustrated in FIG. 14 (b) similarly to the control unit 110-1.

According to the present embodiment, current adjustment is not required when there is no overheating, current adjustment is to be executed only when it is estimated that a large difference occurs in the current flowing through the current path, and the operation can be simplified.

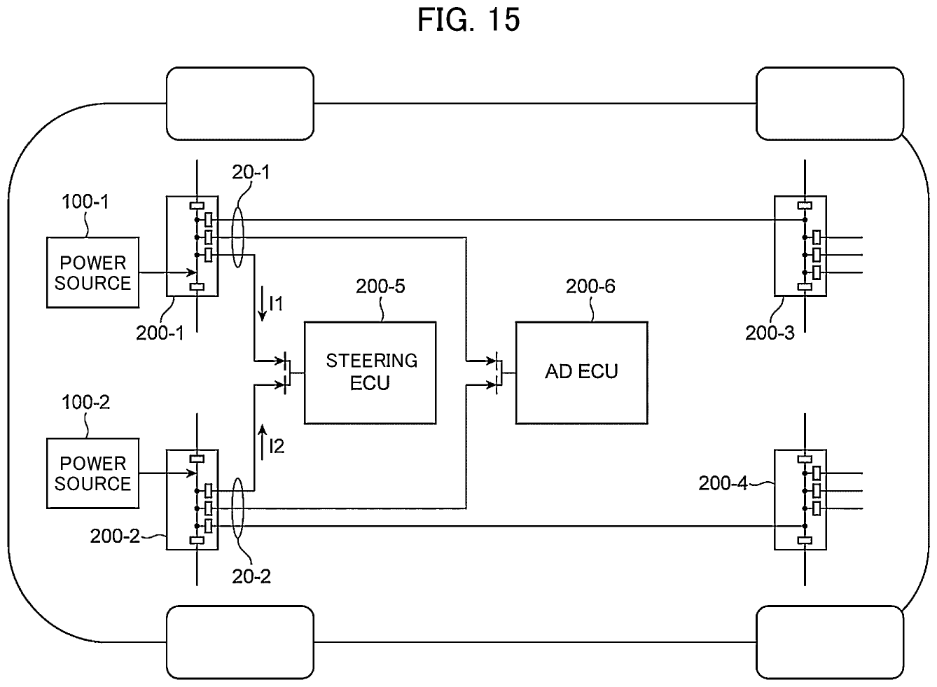

An example of an on-vehicle power supply network mounting a power supply system related to an embodiment of the present invention is illustrated in FIG. 15. As illustrated in FIG. 15, with respect to a vehicle mounting a power supply system related to an embodiment, power is supplied to an important load such as a steering ECU 200-5, an automatic driving (AD) ECU 200-6, and a central gateway (not illustrated) becoming a mediator of communication between respective ECUs from plural power sources 100-1, 100-2 through the electronic control unit 200-1, 200-2 and the current path 20-1, 20-2 respectively. Also, even when a failure may occur in any one of the power source 100-1, 100-2, the electronic control unit 200-1, 200-2, and the current path 20-1, 20-2 and power supply from one current path may be stopped, operation of the important load can be continued by executing the operation explained in FIG. 13 and FIG. 4 and executing power supply form another current path.

Also, to a number of non-important loads other than the important load, power is supplied only from either one of the current paths 20-1, 20-2. As a non-important load, an entertainment system, a heat pump, heater, and electric fan for air conditioning (climate control), a body system, and so on can be cited. In the normal time namely when a failure does not occur in the current path, power is supplied from the current path 20-1, 20-2 to the non-important load and the important load, and a difference is caused in the current flowing through the current path 20-1, 20-2 by power supply to the non-important load. However, by adjusting the power supply to the important load to which power is supplied from both of the current paths 20-1, 20-2 by the present invention, the power supply amount from the current paths 20-1, 20-2 can be balanced. Also, when a failure may occur in either one of the current paths 20-1, 20-2, power is supplied to the important load from another current path, power supply to the non-important load is reduced or stopped, and thereby the power supply capacity of the current path of the normal side can have an allowance. Particularly, with respect to a heat pump, heater, electric fan, and the like, since the thermal time constant is comparatively large, impact of stoppage for a short time is usually small.

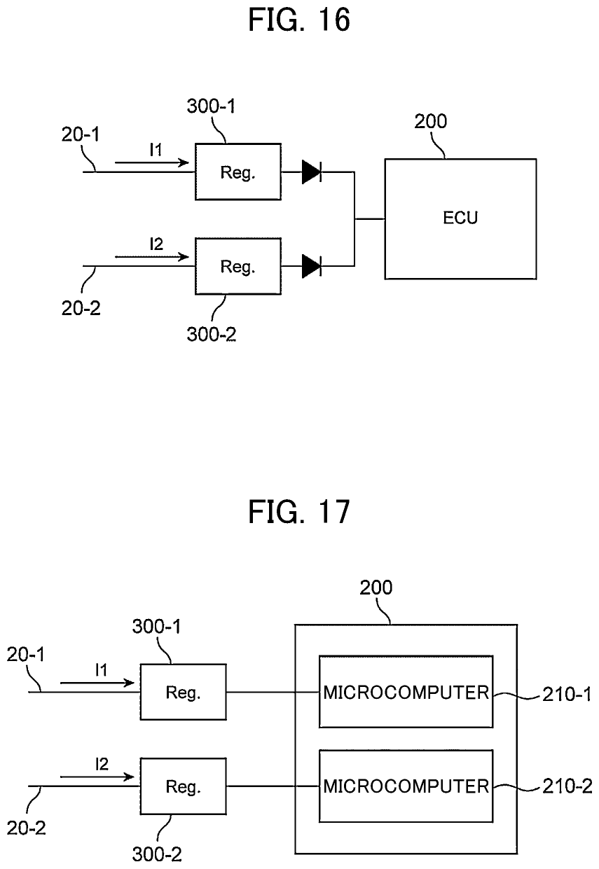

Explanation will be hereinafter made on a concrete example of a method for supplying power from both of the current paths 20-1, 20-2 to an important load such as the steering ECU 200-5 and the automatic driving ECU 200-6. As the simplest method, as illustrated in FIG. 15, current is supplied to the important load through a diode. Also, when a main portion of the ECU 200 such as a microcomputer operates with a voltage stepped down from 12V system to 5V and the like for example, it is possible to provide stepping down regulators 300-1, 300-2 by a plural number, and to supply the voltage output stepped down by the regulators 300-1, 300-2 to the ECU 200 through the diode as illustrated in FIG. 16. Also, when microcomputers 210-1, 210-2 of a plural number are provided for securing redundancy of a microcomputer configuring the ECU 200 as illustrated in FIG. 17, it is also possible to supply the voltage output stepped down by the regulators 300-1, 300-2 provided by a plural number independently for each of the current paths 20-1, 20-2 to the microcomputer 210-1, 210-2 respectively. Also, in the case of FIG. 17, unlike the case of FIG. 16, the regulator 300-1, 300-2 and the microcomputer 210-1, 210-2 are connected directly without involving a diode.

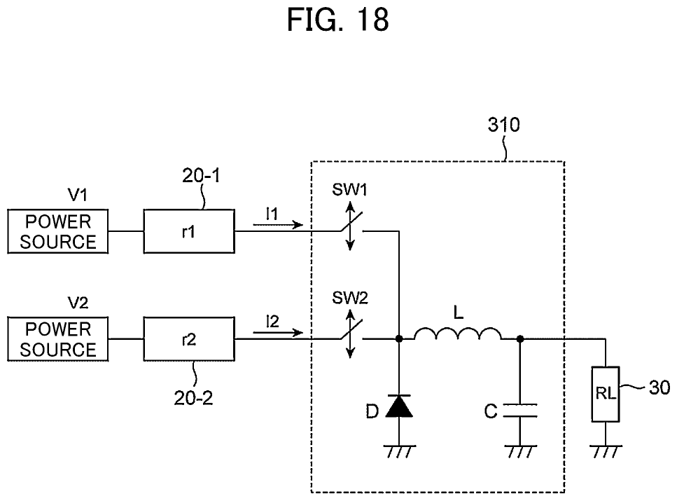

Also, in FIG. 18, there is illustrated an example of a switching power source 310 that is stepped down by switching the power from a plural number of the current paths 20-1, 20-2 by the switching element SW1, SW2. According to the present embodiment, the output voltage can be controlled by changing the duty cycle of switching of the switching element SW1, SW2, and the current from the current path 20-1, 20-2 can be controlled by having different duty cycle of switching of the switching element SW1, SW2. Also, L is a choke coil for smoothing, C is a capacitor for smoothing, and D is a reflux diode.

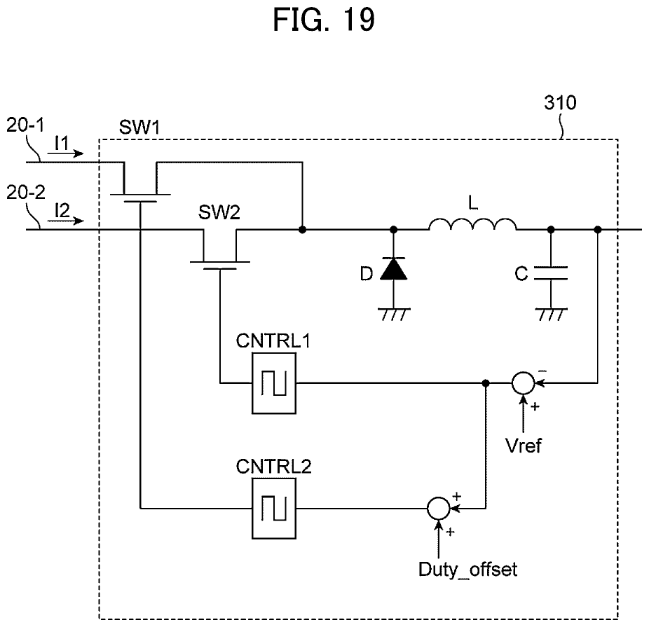

FIG. 19 illustrates a more detailed configuration of the switching power source 310. Difference of the output voltage and a reference voltage Vref is inputted to a control unit CNTRL1, CNTRL2 of the switching power source 310, and is feedback-controlled so that the difference of the output voltage and the reference voltage Vref becomes 0. Here, since a signal added with Duty offset is inputted to CNTRL2, the switching element SW2 executes switching operation with a duty cycle different from that of the switching element SW1, and can set the current I1, I2 from the current path 20-1, 20-2 to a different value.

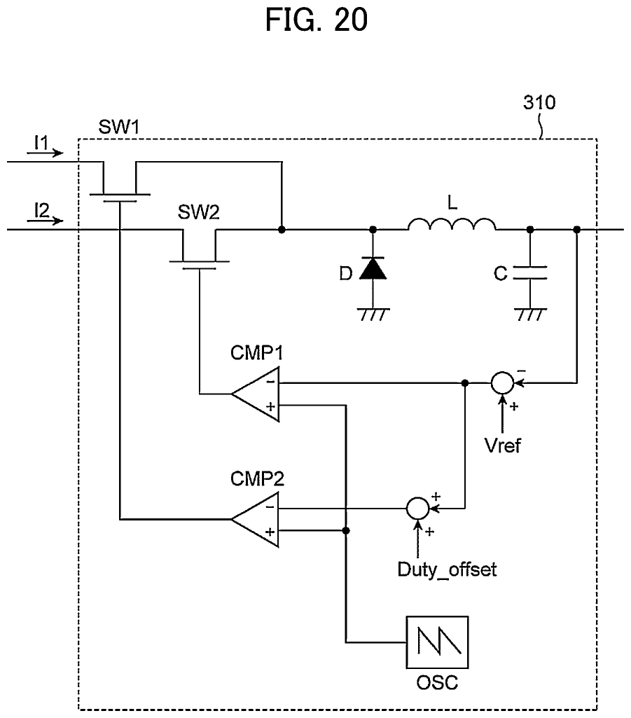

FIG. 20 illustrates a more detailed configuration of the switching power source 310. The control unit CNTRL1, CNTRL2 of the switching power source 310 is configured of a comparator CMP1, CMP2 that compares an input signal and an output of a saw wave or triangle wave generating circuit OSC. Since CMP1, CMP2 drives SW1, SW2 with a predetermined duty cycle by comparing the input signal and the output of the saw wave or triangle wave generating circuit OSC, the current I1, I2 from the current path 20-1, 20-2 can be set to a different value.

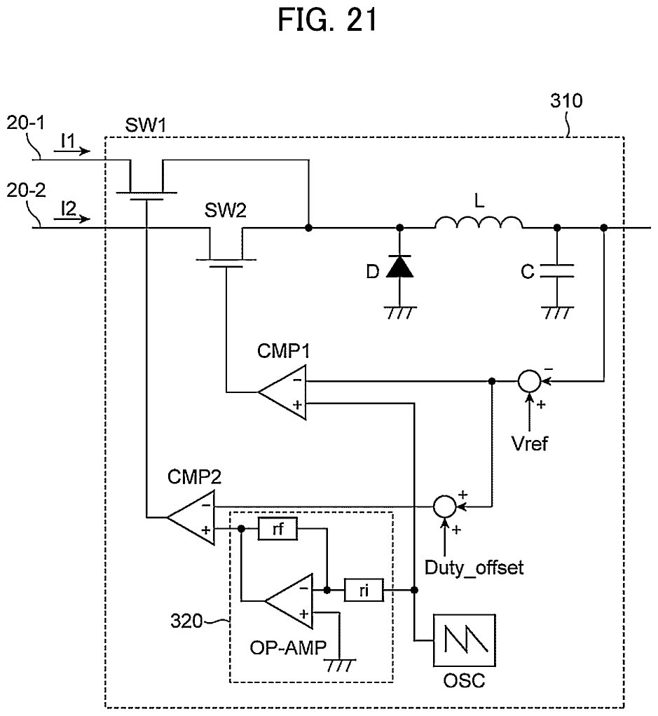

Also, as illustrated in FIG. 21, when an output of the saw wave or triangle wave generating circuit OSC is inverted by an inverting amplifier 320 and is inputted to the comparator CMP2, the switching element SW1, SW2 executes switching operation alternately in opposite phase, and therefore the switching frequency namely the ripple frequency becomes two times, and the value of the product of multiplication of L and C can be made ½. Accordingly, the value of L and C can be made smaller which leads to cost reduction.

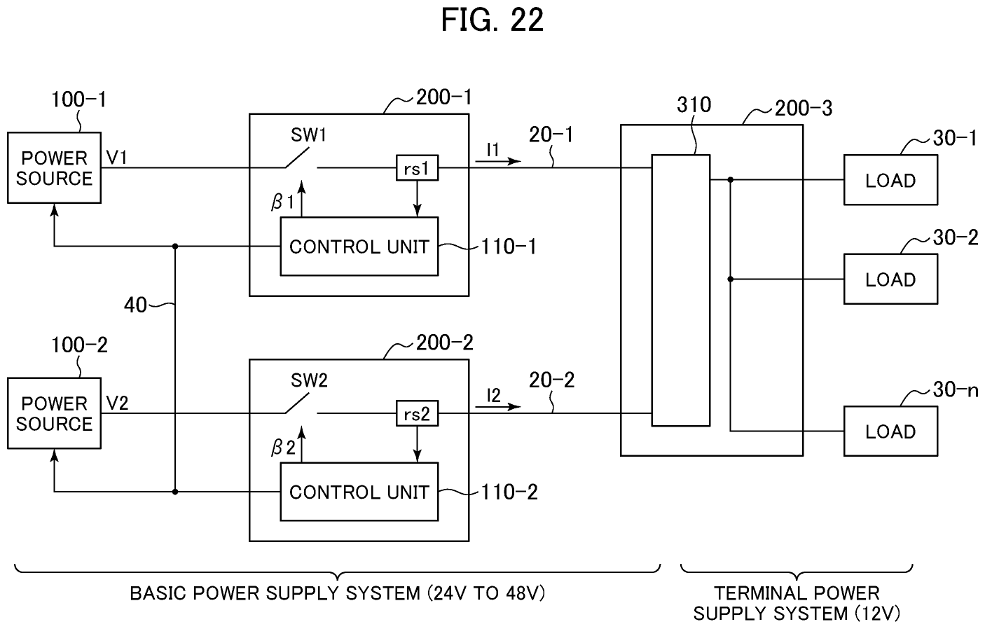

Also, the switching power source 310 according to the present embodiment can be used not only for step down conversion from 12V to 5V but also for such case that the basic power supply system between ECU 200-1 to 200-3 is made a medium voltage of 24V to 48V system, and 12V stepped down from the basic power supply system is supplied to the terminal power supply system to a terminal load connected to each ECU (ECU 200-3 for example) as illustrated in FIG. 22.

According to the embodiment of the present invention described above, actions and effects described below are exerted.
(1) The power supply system related to the present invention includes plural power sources for supplying power to a single load in a vehicle, plural power supply paths for connecting the single load and each of the plural power sources, and a current adjustment unit for adjusting current flowing through the plural power supply paths, and the current control unit compares state quantities of electrical states of each of the power supply paths, and, when a difference between the state quantities meets prescribed conditions, adjusts current flowing through the power supply paths so as to reduce the difference between the state quantities.

By the configuration described above, even when a failure may occur in one current path, power supply to a load can be continued, and an operation of an important load can be continued particularly. Also, in the normal time when a failure does not occur in the current path, by sharing the power supply amount with excellent balance among the current paths arranged by a plural number, the capacity required for each current path can be reduced.
(2) The current adjustment unit adjusts the current flowing through each of the plural power supply paths by a plural number described above. Thus, even when there exist the power supply paths arranged by a plural number and power is required to be adjusted for each of them, response is enabled.
(3) The current adjustment unit adjusts the current flowing through each of the plural power supply paths by pulse width modulation of a different duty cycle. Thus, the duty cycle can be set appropriately, and the utilization efficiency of the power supply path can be optimized.
(4) A part of the ON-period of the current flowing through at least a part of the plural power supply paths among the plural power supply paths overlaps. Thus, since the current flows always in any one of the power supply paths, the current does not become 0 sharply as a whole circuit even when the current of any current path is cut off. Therefore, a reflux diode, a choke coil, and the like required for a normal switching regulator become unnecessary.
(5) The duty cycle that flows through a part of the power supply paths among the plural power supply paths is 100%. Thus, since heat generation of this power supply path reduces compared to the power supply path that is PWM-controlled, heat generation as a whole circuit can be also reduced.
(6) The frequency of the pulse width modulation is shorter than the thermal time constant of the power supply path. In concrete terms, the frequency only may be as slow as approximately several hundreds milliseconds to several seconds. Therefore, increase of the switching loss proportional to the number of times of switching becomes negligible.
(7) There is provided a voltage conversion device converting plural input power from plural power supply paths into a single output power of a voltage different from that of the input power, and pulse width modulation is executed by the voltage conversion device. The inside of an automobile is configured of a basic power supply system with the operation voltage of 24 to 48V, a terminal power supply system with the operation voltage of 12V, and various kinds of ECUs with the operation voltage of 5V for example, and effectiveness of the present invention in the field of the automobile is ensured similarly to the above.
(8) There is further provided the electronic control unit connected to the power source side of each of the plural power supply paths, and pulse width modulation is executed by the electronic control unit. Also, the electronic control unit has a function of measuring the current flowing through the plural power supply paths and/or a function of estimating the temperature of the plural power supply paths. The present invention can be suitably applied to an automobile having a zone architecture and the like which has been developed in recent years.
(9) The electrical state is the temperature of the wiring resistance of the power supply path, and the capacity or the voltage of the power source connected to the power supply path. Thus, monitoring of the state of the power supply path from various viewpoints is enabled, and an appropriate method for adjusting the current can be employed.
(10) Each of the power supply paths is configured of a bundled line that is obtained by bundling plural cables. The present invention can be applied suitably to one having such configuration, namely an automobile for example.
(11) When a failure occurs in a part of the plural power supply paths, power is supplied only from another power supply path among the plural power supply paths. Thus, since the power supply system is configured complementarily, interruption of power supply to an important load can be prevented.

Also, the present invention is not to be limited to the embodiments described above, and various modifications are possible. For example, the embodiments described above were explained in detail for easy understanding of the present invention, and the present invention is not to be necessarily limited to an aspect including all configurations having been explained. Also, a part of a configuration of an embodiment can be substituted by a configuration of other embodiments. Also, a configuration of an embodiment can be added with a configuration of other embodiments. Also, with respect to a part of a configuration of each embodiment, it is possible to effect deletion and to effect addition and substitution of other configurations.

### LIST OF REFERENCE SIGNS

20-1, 20-1: current path (power supply path),
30: load,
100-1, 100-2: power source,
110-1, 110-2: control unit (current adjustment unit),
200-1, 200-2: electronic control unit,
300-1, 300-2: regulator (voltage conversion device)

1. A power supply system comprising:
a plurality of power sources for supplying power to a single load in a vehicle;
a plurality of power supply paths for connecting between the single load and each of the plurality of power sources; and
a current adjustment unit for adjusting current flowing through at least one of the plurality of power supply paths, wherein
the current adjustment unit compares state quantities of electrical states of the respective power supply paths, and when a difference between the state quantities meets prescribed conditions, adjusts current flowing through the power supply paths so as to reduce the difference between the state quantities.

2. The power supply system according to claim 1, wherein
the current adjustment unit adjusts current flowing through each of the plurality of power supply paths.

3. The power supply system according to claim 2, wherein
the current adjustment unit adjusts current flowing through each of the plurality of power supply paths by pulse width modulation with different duty cycle.

4. The power supply system according to claim 2, wherein
a part of on-period of currents flowing at least a part of the plurality of power supply paths among the plurality of power supply paths overlap.

5. The power supply system according to claim 3, wherein
the duty cycle that flows through a part of power supply paths among the plural power supply paths is 100%.

6. The power supply system according to claim 3, wherein
frequency of the pulse width modulation is shorter than a thermal time constant of the power supply path.

7. The power supply system according to claim 3, further comprising:
a voltage conversion device for converting a plurality of input powers from the plurality of power supply paths into a single output power of a voltage different from that of the input power, wherein
the pulse width modulation is executed by the voltage conversion device.

8. The power supply system according to claim 3, further comprising:
an electronic control unit connected to the power source side of each of the plurality of power supply paths, wherein
the pulse width modulation is executed by the electronic control unit.

9. The power supply system according to claim 8, wherein
the electronic control unit has a function for measuring current flowing through the plurality of power supply paths.

10. The power supply system according to claim 8, wherein
the electronic control unit has a function for estimating temperature of the plurality of power supply paths.

11. The power supply system according to claim 1, wherein
the electrical state is temperature of wiring resistance of the power supply path.

12. The power supply system according to claim 1, wherein
the electrical state is capacity of a power source connected to the power supply path.

13. The power supply system according to claim 1, wherein
the electrical state is voltage of a power source connected to the power supply path.

14. The power supply system according to claim 1, wherein
each of the power supply paths is configured of a bundled line that is obtained by bundling a plurality of cables.

15. The power supply system according to claim 1, wherein,
when a failure occurs in a part of the plurality of power supply paths, power is supplied only from other power supply paths among the plurality of power supply paths.
